(19) United States
(12) Patent Application Publication
(10) Pub. No.: US 2026/0342517 A1
(43) Pub. Date: Oct. 29, 2026

(54) TWO-STAGE CHANNEL SOUNDING PROCEDURE IN A WIRELESS COMMUNICATION SYSTEM

(71) Applicant: QUALCOMM Incorporated, San Diego, CA (US)

(72) Inventors: Hua WANG, Basking Ridge, NJ (US); Divyansh KAREMORE, San Diego, CA (US); Arumugam CHENDAMARAI KANNAN, San Diego, CA (US); Tao LUO, San Diego, CA (US); Junyi LI, Greentown, PA (US)

(21) Appl. No.: 19/187,760

(22) Filed: Apr. 23, 2025

(51) Int. Cl. H04L 5/00; H04B 7/06; H04L 1/00; H04W 72/20

(52) U.S. Cl. CPC H04L 5/0051; H04B 7/0626; H04L 1/0003; H04W 72/20

(57) ABSTRACT

This disclosure provides methods, components, devices and systems for two-stage channel sounding procedure in a wireless communication system. For example, a user equipment (UE) may receive first control signaling allocating at least a first sounding reference signal (SRS) resource set including a first set of resources for transmission of one or more SRSs. The UE may transmit a first set of SRSs via the first SRS resource set during a first stage of a two-stage sounding procedure. The UE may receive second control signaling indicating a precoding matrix based at least in part on transmitting the first set of SRSs, and the UE may transmit a second set of SRSs via a second SRS resource set during a second stage of the two-stage sounding procedure according to a precoding scheme corresponding to the precoding matrix indicated via the second control signaling.

### TECHNICAL FIELD

This present disclosure relates generally to wireless communication, and more specifically to systems, devices, methods, and techniques associated with two-stage channel sounding procedure in a wireless communication system.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network nodes (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving first control signaling allocating at least a first sounding reference signal (SRS) resource set including a first set of resources for transmission of one or more SRSs, transmitting a first set of SRSs via the first SRS resource set during a first stage of a two-stage sounding procedure, receiving second control signaling indicating a precoding matrix based on transmitting the first set of SRSs, and transmitting a second set of SRSs via a second SRS resource set during a second stage of the two-stage sounding procedure according to a precoding scheme corresponding to the precoding matrix indicated via the second control signaling.

A UE for wireless communications is described. The UE may include a processing system that includes processor circuitry and memory circuitry that stores code. The processing system may be configured to cause the UE to receive first control signaling allocating at least a first SRS resource set including a first set of resources for transmission of one or more SRSs, transmit a first set of SRSs via the first SRS resource set during a first stage of a two-stage sounding procedure, receive second control signaling indicating a precoding matrix based on transmitting the first set of SRSs, and transmit a second set of SRSs via a second SRS resource set during a second stage of the two-stage sounding procedure according to a precoding scheme corresponding to the precoding matrix indicated via the second control signaling.

Another UE for wireless communications is described. The UE may include means for receiving first control signaling allocating at least a first SRS resource set including a first set of resources for transmission of one or more SRSs, means for transmitting a first set of SRSs via the first SRS resource set during a first stage of a two-stage sounding procedure, means for receiving second control signaling indicating a precoding matrix based on transmitting the first set of SRSs, and means for transmitting a second set of SRSs via a second SRS resource set during a second stage of the two-stage sounding procedure according to a precoding scheme corresponding to the precoding matrix indicated via the second control signaling.

A non-transitory computer-readable medium storing code for wireless communications is described. The code may include instructions executable by one or more processors to receive first control signaling allocating at least a first SRS resource set including a first set of resources for transmission of one or more SRSs, transmit a first set of SRSs via the first SRS resource set during a first stage of a two-stage sounding procedure, receive second control signaling indicating a precoding matrix based on transmitting the first set of SRSs, and transmit a second set of SRSs via a second SRS resource set during a second stage of the two-stage sounding procedure according to a precoding scheme corresponding to the precoding matrix indicated via the second control signaling.

Some examples of the method, UEs, and non-transitory computer-readable medium described herein may further include operations, features, means, or instructions for receiving third control signaling indicating a rank, a number of layers, and a modulation and coding scheme (MCS) to be applied to an uplink transmission by the UE based on transmitting the second set of SRSs according to the precoding scheme corresponding to the precoding matrix indicated via the second control signaling.

Some examples of the method, UEs, and non-transitory computer-readable medium described herein may further include operations, features, means, or instructions for transmitting the uplink transmission according to the rank, the number of layers, and the MCS indicated via the third control signaling.

In some examples of the method, UEs, and non-transitory computer-readable medium described herein, the rank, the number of layers, and the MCS may be based on an uplink gain factor corresponding to transmitting the second set of SRSs.

A method for wireless communications by a UE is described. The method may include receiving first control signaling indicating at least a first channel state information-reference signal (CSI-RS) resource set including a first set of resources for one or more CSI-RSs, receiving a first set of CSI-RSs via the first CSI-RS resource set during a first stage of a two-stage sounding procedure, transmitting a control message indicating a precoding matrix based on the first set of CSI-RSs, and receiving a second set of CSI-RSs via a second CSI-RS resource set during a second stage of the two-stage sounding procedure according to a precoding scheme corresponding to the precoding matrix indicated via the control message.

A UE for wireless communications is described. The UE may include a processing system that includes processor circuitry and memory circuitry that stores code. The processing system may be configured to cause the UE to receive first control signaling indicating at least a first CSI-RS resource set including a first set of resources for one or more CSI-RSs, receive a first set of CSI-RSs via the first CSI-RS resource set during a first stage of a two-stage sounding procedure, transmit a control message indicating a precoding matrix based on the first set of CSI-RSs, and receive a second set of CSI-RSs via a second CSI-RS resource set during a second stage of the two-stage sounding procedure according to a precoding scheme corresponding to the precoding matrix indicated via the control message.

Another UE for wireless communications is described. The UE may include means for receiving first control signaling indicating at least a first CSI-RS resource set including a first set of resources for one or more CSI-RSs, means for receiving a first set of CSI-RSs via the first CSI-RS resource set during a first stage of a two-stage sounding procedure, means for transmitting a control message indicating a precoding matrix based on the first set of CSI-RSs, and means for receiving a second set of CSI-RSs via a second CSI-RS resource set during a second stage of the two-stage sounding procedure according to a precoding scheme corresponding to the precoding matrix indicated via the control message.

A non-transitory computer-readable medium storing code for wireless communications is described. The code may include instructions executable by one or more processors to receive first control signaling indicating at least a first CSI-RS resource set including a first set of resources for one or more CSI-RSs, receive a first set of CSI-RSs via the first CSI-RS resource set during a first stage of a two-stage sounding procedure, transmit a control message indicating a precoding matrix based on the first set of CSI-RSs, and receive a second set of CSI-RSs via a second CSI-RS resource set during a second stage of the two-stage sounding procedure according to a precoding scheme corresponding to the precoding matrix indicated via the control message.

Some examples of the method, UEs, and non-transitory computer-readable medium described herein may further include operations, features, means, or instructions for transmitting a second control message indicating a rank, a number of layers, and a MCS to be applied to a downlink transmission based on receiving the second set of CSI-RSs.

Some examples of the method, UEs, and non-transitory computer-readable medium described herein may further include operations, features, means, or instructions for receiving the downlink transmission based on the rank, the number of layers, and the MCS indicated via the second control message.

In some examples of the method, UEs, and non-transitory computer-readable medium described herein, the rank, the number of layers, and the MCS may be based on a downlink gain factor corresponding to transmitting the second set of CSI-RSs.

### BRIEF DESCRIPTION OF THE DRAWINGS

FIG. 1 shows an example of a wireless communication system.

FIG. 2 shows an example of a signaling configuration that supports two-stage channel sounding procedure in a wireless communication system.

FIG. 3 shows an example of a process flow that supports two-stage channel sounding procedure in a wireless communication system.

FIG. 4 shows an example of a process flow that supports two-stage channel sounding procedure in a wireless communication system.

FIG. 5 shows a block diagram of a processing system that supports two-stage channel sounding procedure in a wireless communication system.

FIG. 6 shows a diagram of a system including a device that supports two-stage channel sounding procedure in a wireless communication system.

FIGS. 7 through 10 show flowcharts illustrating methods that support two-stage channel sounding procedure in a wireless communication system.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communications systems may support communicating via a repeater, where signals transmitted via the repeater are amplified and forwarded to improve signal transmission and reception. For example, when performing a channel sounding procedure, a user equipment (UE) and a network node may communicate signals (e.g., sounding reference signals (SRSs), channel state information-reference signals (CSI-RSs)) via the repeater to determine transmission parameters to be applied to subsequent transmissions. However, when communicated via the repeater, signals transmitted in the uplink and downlink directions may be associated with different gain values. For example, an uplink signal received by the network node vi the repeater may be associated with an uplink gain value that is different than a downlink gain value associated with a downlink signal received by the UE via the repeater (e.g., as a result of the multiple hops of the wireless communications via the repeater). Due to the lack of channel reciprocity when communicating via the repeater, signals transmitted during a single-stage channel sounding procedure may not provide accurate information about a communication channel between the UE and the network node after being forwarded by the repeater. As a result, the transmission parameters selected to be applied to the subsequent transmissions may not be suited to the channel conditions between the UE and the network node.

Accordingly, aspects of the subject matter described in this disclosure relate to a two-stage sounding procedure, where two sets of signals are exchanged between the UE and the network node via the repeater during two respective stages (e.g., phases) before selecting the transmission parameters to be applied to the subsequent transmissions. For example, when performing a two-stage uplink sounding procedure, the UE may transmit a first set of SRSs, which may be precoded according to an identity matrix, to the network node during a first stage of the two-stage sounding procedure. In response, the UE may receive an indication of a precoding matrix, which may be determined by the network node based on measurements of the first set of SRSs, the identity matrix, and an uplink gain factor applied to first set of SRSs by the repeater. The UE may transmit a second set of SRSs according to a precoding scheme corresponding to the precoding matrix indicated by the network node during a second stage of the two-stage sounding procedure, which may be measured by the network node to determine one or more transmission parameters for subsequent uplink transmissions by the UE. As such, the one or more transmission parameters may account for the uplink gain factor applied to the second set of SRSs by the repeater, and may be better suited to the communication channel between the UE and the network node. A similar procedure may be conducted for a downlink channel sounding procedure, where the network node may transmit two sets of CSI-RSs to the UE, and the UE may determine one or more transmission parameters for subsequent downlink transmissions by the network node. As such, the two-stage sounding procedure may provide the UE or the network node with accurate information about the channel between the UE and the network node when communicating via a repeater, which may improve transmission parameter selection for subsequent communications (e.g., compared to systems using a single-stage channel sounding procedure when communicating via a repeater).

Particular aspects of the subject matter described in this disclosure can be implemented to realize one or more of the following potential advantages. In some examples, by transmitting two sets of signals during two respective stages (e.g., phases) of the two-stage sounding procedure, the network node or the UE may be able to obtain information about a gain factor being applied to signals by the repeater, and may be able to account for the gain factor when selecting the transmission parameters to be applied to subsequent transmissions. As such, the transmission parameters may be better suited to the channel between the UE and the network node, as the UE and the network node have accurate information about the channel when selecting the transmission parameters. Therefore, the described techniques, systems, and devices may be implemented to maintain channel reciprocity when communicating via a repeater, improving the accuracy and reliability of channel sounding procedures. Such techniques may therefore result in more accurate selection of parameters for wireless communications, improved reliability of wireless signaling, improved throughput, decreased system latency, and improved user experience.

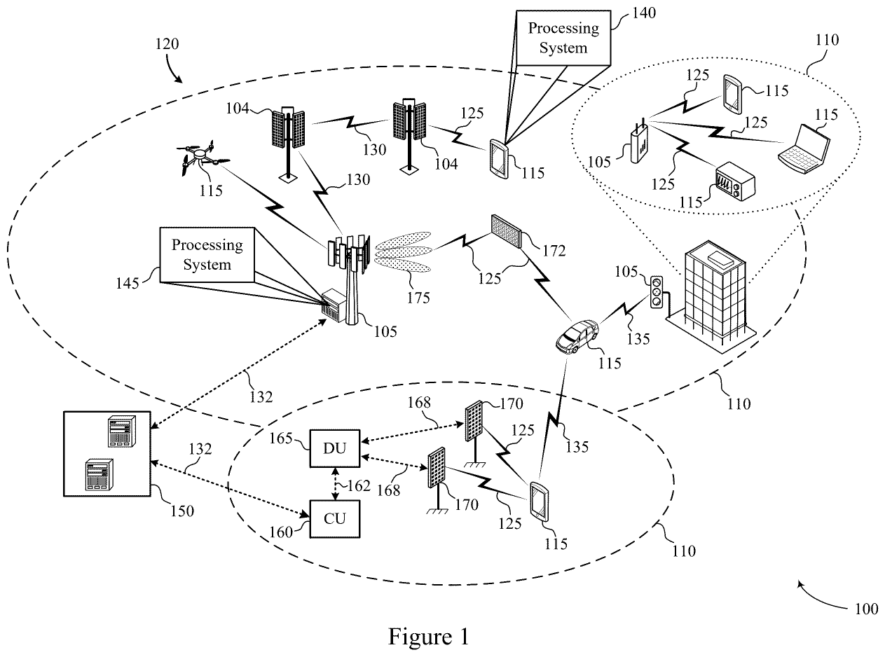

FIG. 1 shows an example of a wireless communication system 100. The wireless communication system 100 includes a core network 150 and a RAN 120 that support communication with one or more devices, such as UEs 115. A RAN 120 may include one or more network nodes 105 configured to support wireless communication with the UEs 115.

The wireless communication system 100 may support communication among network nodes 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network node 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network nodes 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network node 105 may support wireless communication in accordance with one or more coverage areas 110, and may be referred to as a network element, a network node, a RAN node, or network equipment, among other nomenclature. One or more of the network nodes 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network nodes 105 support communication for one or more coverage areas 110 using the same or different RATs.

In some examples, a network node 105 may be implemented in an aggregated (such as monolithic, standalone) architecture, which may utilize a protocol stack that is physically or logically integrated within one network node 105 (such as a single physical RAN node). In some other examples, a network node 105 may be implemented in a disaggregated architecture, which may utilize a protocol stack that is physically or logically distributed among multiple network nodes 105, including in an integrated access and backhaul (IAB) network, an open RAN (O-RAN), or a virtualized RAN (vRAN). In a disaggregated architecture, a network node 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network nodes 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network node 105 and a UE 115 may be supported using one or more of a communication link 125 (such as a Uu interface), which may include downlink communication from a network node 105 to a UE 115, uplink communication from a UE 115 to a network node 105, or both. Direct wireless communication between UEs 115 may be supported using a communication link 135 (such as a device-to-device (D2D) communication link, a sidelink, a PC5 interface).

Communication between a network node 105 and a core network 150 may be supported using a backhaul link 132 (such as an S1, N2, N3, NG, or other interface). In some implementations, communication between network nodes 105 may be supported using a backhaul link 132 (such as an X2, Xn, or other interface) either directly (such as directly between network nodes 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network node 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network nodes 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network node 105 or a UE 115.

Beamforming, such as directional transmission or directional reception, is a signal processing technique that may be used at a transmitting device or a receiving device (such as at a network node 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network node 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network node 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network node 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network node 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network nodes 105 and UEs 115 may include synchronization signals (such as a primary synchronization signal (PSS), a secondary synchronization signal (SSS)) that support temporal synchronization, CSI-RSs that support evaluating downlink channel characteristics, SRSs that support evaluating uplink channel characteristics, demodulation reference signals (DMRSs) that support demodulation, or phase tracking reference signals (PTRSs) for evaluating oscillator characteristics, among others. Network nodes 105 and UEs 115 may receive and measure transmitted reference signals to support one or more of these and other functions.

Devices of the wireless communication system 100 may be configured to support one or more aspects of the described techniques for two-stage channel sounding procedure in a wireless communication system. For example, a UE 115 may include a processing system 140, and a network node 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support two-stage channel sounding for transmission parameter selection, which may improve communication reliability compared to systems using single-stage channel sounding.

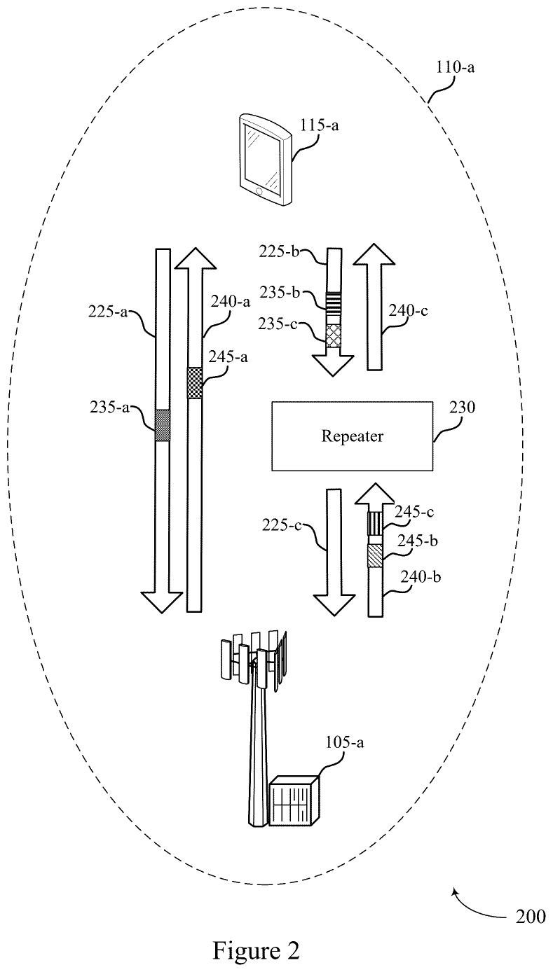

FIG. 2 shows an example of a signaling configuration 200 that supports a two-stage channel sounding procedure in a wireless communication system. The signaling configuration 200 may implement or be implemented by aspects of the wireless communications system 100 as described with reference to FIG. 1. For example, the signaling configuration 200 may include a network node 105-a and a UE 115-a, which may represent examples of a network node 105 and a UE 115, or some other devices, as described with reference to FIG. 1. The network node 105-a may communicate (e.g., directly) with the UE 115-a within a geographic coverage area 110-a and via an uplink communication link 225-a (e.g., a Uu link). In other cases, as described herein, the network node 105-a may communicate with the UE 115-a via a repeater 230 using the UE-to-repeater communication link 225-b and the repeater-to-network node communication link 225-c. In some examples, the UE 115-a may transmit one or more SRSs to the network node 105-a during a channel sounding procedure.

In some wireless communication systems, a single-stage channel sounding procedure may be supported to select parameters for subsequent transmissions by the UE 115-a and the network node 105-a. For example, when conducting a single-stage channel sounding procedure (e.g., a non-codebook based single-stage channel sounding procedure, a codebook based single-stage channel sounding procedure), the UE 115-a may transmit a set of SRSs 235-a, to the network node 105-a via the UE-to-repeater communication link 225-b. The network node 105-a may measure the set of SRSs 235-a to determine one or more transmission parameters, such as an uplink precoding matrix, a rank, a modulation and coding scheme (MCS), or any combination thereof, to be applied to subsequent uplink transmissions by the UE 115-a. The network node may indicate the one or transmission parameters (e.g., via a rank indicator (RI), an uplink precoding matrix indicator (PMI)) to the UE 115-a, which may then apply the transmission parameters to subsequent uplink transmissions to the network node 105-a.

In cases where the UE 115-a and the network node 105-a are communicating without the repeater 230 (e.g., via a one hop link, such as the uplink communication link 225-a), there may be channel reciprocity between an uplink channel and a downlink channel via which the UE 115-a and the network node 105-a are communicating. As such, the network node 105-a may obtain accurate information about the uplink channel based on measurements of the set of SRSs 235-a. For example, the first set of SRS 235-a may be received at the network node 105-a according to a value Y_{UL,SRS}, which may be based on a channel (e.g., a channel matrix) H associated with the uplink communication link 225-a, a power at the UE 115-a P_{UE}, an antenna at the UE 115-a Nt_{UE}, the set of SRSs-235-a (represented as X_{UL,SRS}), and noise Z. Accordingly, the set of SRSs 235-a may be received at the network node 105-a according to Equation 1:

$${Y}_{UL , SRS} = \sqrt{\frac{{P}_{UE}}{{Nt}_{UE}}} * H * {X}_{UL , SRS} + Z$$

As such, a downlink transmission may be received at the UE 115-a according to a value Y_{DL}, which may be based on a transpose of the channel matrix H^{T}, a power at the network node 105-a P_{NB}, an antenna at the network node 105-a Nt_{NB}, the downlink transmission X_{DL}, and noise Z. Accordingly, the downlink transmission may be received at the network node 105-a according to Equation 2:

$${Y}_{DL} = \sqrt{\frac{{P}_{Nb}}{{Nt}_{Nb}}} * {H}^{T} * {X}_{DL} + Z$$

Thus, when communicating without the repeater 230, the uplink channel and the downlink channel may have a reciprocal relationship (e.g., the downlink channel is a constant factor of the transpose of the uplink channel) enabling the network node 105-a to accurately determine the channel conditions between the network node 105-a and the UE 115-a by measuring the set of SRSs 235-a. As such, the transmission parameters selected by the network node 105-a may be suited to the channel conditions between the UE 115-a and the network node 105-a, offering sufficient communication reliability.

However, some wireless communication systems may support communications via the repeater 230 (e.g., a simple repeater), which may amplify and forward communications between the network node 105-a and the UE 115-b. In some such examples, one or more devices may lack beamforming capabilities. In such cases, channel reciprocity between the downlink channel and the uplink channel may not be maintained as the repeater 230 may apply different gain factors to signals in the uplink and downlink directions. The loss of channel reciprocity may reduce the ability of the network node 105-a to accurately sound SRSs transmitted by the UE 115-a during the single-stage channel sounding procedure, and the network node 105-a may be unable to select transmission parameters that are suited to the channel between the UE 115-a and the network node 105-a.

For example, the repeater 230 may support one-to-one input antenna to output antenna amplification, where a gain factor G for each antenna can be set to satisfy one or more power constraints (e.g., a per-antenna power constraint, a total power constraint for all transmit antennas). As such, when amplified and forwarded via the repeater 230, a set of SRSs received at the network node 105-a may be based on an additional uplink gain factor G_{UL,SRS} applied by the repeater 230, as well as the channel matrix H₁ associated with the UE-to-repeater communication link 225-b (e.g., a first hop link) and the channel matrix H₂ associated with the repeater-to-network node communication link 225-c (e.g., a second hop link). Accordingly, the set of SRSs transmitted by the UE 115-a via the repeater 230 may be received by the network node 105-a according to the value Y_{UL,SRS}, as expressed by Equation 3:

$${Y}_{UL , SRS} = \sqrt{\frac{{P}_{UE}}{{Nt}_{UE}}} * {H}_{1} * {G}_{UL , SRS} * {H}_{2} * {X}_{UL , SRS} + Z$$

Similarly, the downlink transmission may be received by the UE 115-a according to a value Y_{DL}, which may be based on an additional downlink gain factor G_{DL} applied by the repeater 230, as well as the transpose of the channel matrix H₁ and the transpose of the channel matrix H₂. As such, the downlink transmission may be received according to the value Y_{DL}, as expressed by Equation 4:

$${Y}_{DL} = \sqrt{\frac{{P}_{Nb}}{{Nt}_{Nb}}} * {H}_{2}^{T} * {G}_{DL} * {H}_{1}^{T} * {X}_{DL} + Z$$

Since the uplink gain factor G_{UL,SRS} is not a constant factor of the transpose of the downlink gain G_{DL}, reciprocity between the downlink channel and the uplink channel is lost when communicating via the repeater 230. As such, the network node 105-a may select a precoding matrix V, a rank, a number of layers, and a MCS, among other examples, to be applied to an uplink transmission (e.g., a PUSCH) by the UE 115-a based on the uplink gain factor G_{UL,SRS}, while the network node 105-a may actually receive the uplink transmission according to a second uplink gain factor, such as G_{UL,PUSCH}. Therefore, the rank, the number of layers, and the MCS may be better suited for communicating the uplink transmission if selected by the network node 105-a based on the second uplink gain factor, G_{UL,PUSCH}, which requires the network node 105-a to have information about the UE-to-repeater communication link 225-b.

Accordingly, techniques, systems, and devices described herein provide for the UE 115-a and the network node 105-a to perform a two-stage sounding procedure when communicating via a repeater, where two sets of reference signals are exchanged between the UE 115-a and the network node 105-a during two respective stages before selecting transmission parameters to be applied to subsequent transmissions. For example, when performing a two-stage uplink channel sounding procedure, the UE 115-a may receive (e.g., from the network node 105-a) first control signaling allocating at least a first SRS resource set, which may include resources for transmission of a first set of SRSs 235-b. The UE 115-a may transmit (e.g., to the network node 105-a), via the first SRS resource set and during a first stage of the two-stage sounding procedure, the first set of SRSs 235-b according to a precoding scheme that corresponds to an identity precoding matrix V₁. The first set of SRSs 235-b may be transmitted via the UE-to-repeater communication link 225-b to the repeater 230, which may amplify and forward the first set of SRSs 235-b to the network node 105-a via the repeater-to-network node communication link 225-c. The repeater 230 may apply an uplink gain factor to the first set of SRSs 235-b when forwarding the first set of SRSs 235-b via the repeater-to-network node communication link 225-c.

As such, by transmitting the first set of SRSs 235-b precoded according to the identity matrix V₁, the network node 105-a may obtain (e.g., compute) a precoding matrix V₂ to be applied by the UE 115-a to a subsequent uplink transmission. For example, the network node 105-a may calculate the precoding matrix V₂ according to Equation 5:

$${V}_{2} = \sqrt{\frac{{P}_{UE}}{{Nt}_{UE}}} * {H}_{1} * {G}_{UL , SRS} * {H}_{2} * {V}_{1} * {X}_{UL , SRS}$$

which may account for the uplink gain factor G_{UL,SRS} applied to the first set of SRSs 235-b. Thus, the network node 105-a may determine the precoding matrix V₂ for the subsequent uplink transmission by the UE 115-a based on precoding information indicated by the first set of SRSs 235-b during the first stage of the two-stage sounding procedure.

Accordingly, the UE 115-a may receive second control signaling indicating the precoding matrix V₂ (e.g., via a transmission PMI (TPMI) included in the second control signaling). The UE 115-a may transmit a second set of SRSs 235-c via a second SRSs resource set (e.g., which may be indicated by the first control signaling or by a sounding resource indicator (SRI) included in the second control signaling) during a second stage of the two-stage sounding procedure, where the UE 115-a may apply a precoding scheme to the second set of SRSs 235-c that corresponds to the precoding matrix V₂. As the network knows the precoding scheme applied to the second set of SRSs 235-c, the network node 105-a may be able to derive information about the UE-to-repeater communication link 225-b based on measurements of the second set of SRSs 235-c, such as the uplink gain factor G_{UL,SRS} applied by the repeater 230. As such, the network node 105-a may determine transmission parameters, such as a rank, a number of layers, and a MCS, for the UE 115-a to apply to the subsequent uplink transmission that accounts for an uplink gain factor, such as G_{UL,PUSCH}, that will be applied to the subsequent uplink transmission according to Equation 6:

$${V}_{3} = \sqrt{\frac{{P}_{UE}}{{Nt}_{UE}}} * {H}_{1} * {G}_{UL , PUSCH} * {H}_{2} * {V}_{2} * {X}_{UL , SRS}$$

As such, the UE may 115-a may receive control signaling that indicates the rank (e.g., via a RI), the number of layers (e.g., via a layer indicator (LI)), and the MCS determined by the network node 105-a, and may transmit an uplink transmission according to the rank, the number of layers, and the MCS indicated via the third control signaling, which may be better suited to the channel conditions between the network node 105-a and the UE 115-a.

In some cases, a similar procedure may be conducted for a two-stage downlink sounding procedure, where the network node 105-a may transmit two sets of CSI-RSs to the UE 115-a, and the UE 115-a may determine one or more transmission parameters for subsequent downlink transmissions by the network node 105-a. for example, the network node 105-a may communicate (e.g., directly) with the UE 115-a via a downlink communication link 240-a. In other cases, the network node 105-a may communicate with the UE 115-a via a repeater 230 using the network node-to-repeater communication link 240-b and the repeater-to-UE communication link 240-c. When communicating via the downlink communication link 240-a, the UE 115-a may receive a set of CSI-RSs 245-a, which the UE 115-a may measure to select one or more transmission parameters (e.g., a rank, a number of layers, a MCS) to be applied to subsequent downlink transmissions by the network node 105-a. In such cases, measurements of the set of CSI-RSs 245-a may provide accurate information about channel conditions associated with the downlink communication link 240-a.

In, other cases, the UE 115-a and the network node 105-a may communicate via the repeater 230, and the UE 115-a may not have information about the network node-to-repeater communication link 240-b. As such, receiving two sets of CSI-RSs during two separate stages of the downlink channel sounding procedure may provide the UE 115-a with information to select suitable transmission parameters for the subsequent downlink transmissions by the network node 105-a. Accordingly, in some examples, the UE 115-a may receive first control signaling that indicates at least a first CSI-RS resource set including a first set of resources for receiving one or more CSI-RSs. The UE 115-a may receive a first set of CSI-RSs 245-b via the first CSI-RS resource set during a first stage of the two-stage downlink sounding procedure. The first set of CSI-RSs 245-b may be transmitted according to a precoding scheme that corresponds to the identity precoding matrix V₁, and may be received based on a downlink gain G_{DL,CSI-RS} applied by the repeater 230 to the first set of CSI-RSs 245-b when transmitted to the UE 115-a via the repeater-to-UE communication link 240-c. The UE 115-a may determine (e.g., compute) a precoding matrix to be applied to a second set of CSI-RSs 245-c subsequently transmitted by the network node 105-a based on the downlink gain factor G_{DL,CSI-RS} and the identity matrix V₁. For example, the UE 115-a may determine the precoding matrix by performing calculations similar to those detailed in Equation 5, and the UE 115-a may indicate the precoding matrix to the network node 105-a via a control message.

During a second stage of the two-stage sounding procedure, the UE 115-a may receive the second set of CSI-RSs 245-c via a second CSI-RS resource set, where the second set of CSI-RSs 245-c may be transmitted according to a precoding scheme that corresponds to the precoding matrix indicated via the control message. Based on knowing the precoding scheme applied to the second set of CSI-RSs 245-c, the UE 115-a may derive information about network node-to-repeater communication link 240-b based on measurements of the second set of CSI-RSs 245-c. For example, the UE 115-a may determine a downlink gain, such as G_{DL,PDSCH}, associated with a subsequent downlink transmission by the network node 105-a based on measurements of the second set of CSI-RSs 245-c. As such the UE 115-a may determine a rank, a number of layers, and a MCS to be applied to the subsequent downlink transmission, where the rank, the number of layers, and the MCS may be based on the downlink gain G_{DL,PDSCH} applied by the repeater 230 to the second set of CSI-RSs 245-c as well as the precoding matrix calculated by the UE 115-a. For example, the UE 115-a may compute the rank, the number of layers, and the MCS to be applied to the subsequent downlink transmission according to similar calculations as those described by Equation 6. The UE 115-a may indicate the rank, the number of layers, and the MCS to the network node 105-a via a second control message, and the UE 115-a may receive the subsequent downlink transmission according to the rank, the number of layers, and the MCS indicated via the second control message. As such, the two-stage sounding procedure may provide the UE 115-a or the network node 105-a with accurate information about a channel (e.g., the UE-to-repeater communication link 225-b or the network node-to-repeater communication link 240-b) between the UE 115-a and the network node 105-a when communicating via the repeater 230, which may improve transmission parameter selection compared to systems using a single-stage channel sounding procedure when communicating via a repeater.

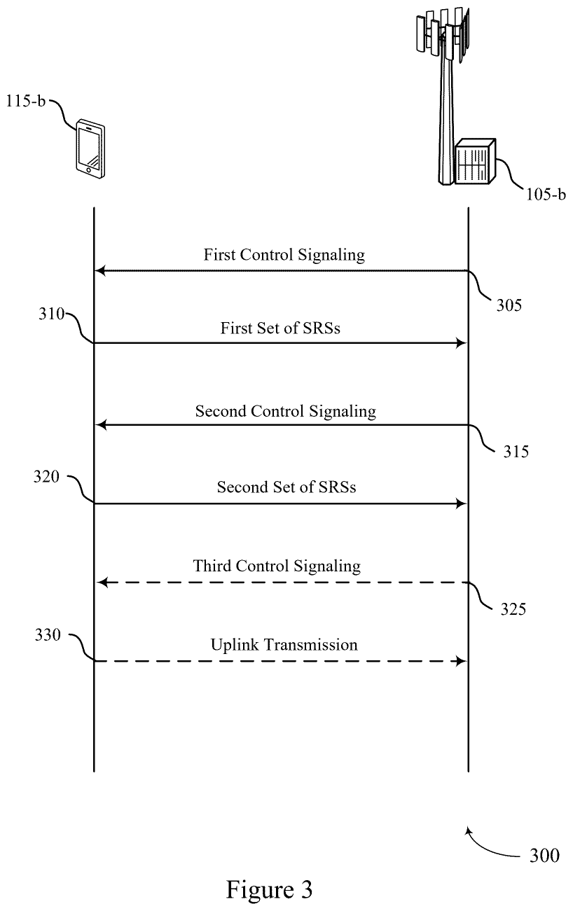

FIG. 3 shows an example of a process flow 300 that supports a two-stage sounding procedure in a wireless communication system. The process flow 300 may implement aspects of or may be implemented by aspects of the wireless communications system 100 or the signaling configuration 200. For example, the process flow 300 may include a UE 115-b and a network node 105-b, which may be examples of the corresponding devices as described with reference to FIGS. 1 and 2. In some cases, the UE 115-b and the network node 105-b may communicate via a repeater, which may receive signals from the UE 115-b and amplify and forward the signals to the network node 105-b.

At 305, the UE 115-b may receive first control signaling allocating at least a first SRS resource set that includes a first set of resources for transmission of one or more SRSs. In some cases, the first control signaling may additionally allocate a second SRS resource set including a second set of SRS resources for transmission of one or more second SRSs. As such, the first control signaling may allocate resources for the UE 115-b to perform the two-stage sounding procedure (e.g., a two-stage uplink channel sounding procedure) in which the UE 115-b may transmit two sets of SRSs during two respective stages of the two-stage sounding procedure.

At 310, the UE 115-b may transmit a first set of SRSs to the network node 105-b via the first SRS resource set. The UE 115-b may transmit the first set of SRSs during a first stage of the two-stage sounding procedure, and may precode the first set of SRSs according to a precoding scheme corresponding to an identity matrix. As such, the network node 105-b may receive the first set of SRSs from the UE 115-a via the repeater, which may apply an uplink gain the first set of SRSs.

At 315, the UE 115-b may receive second control signaling indicating a precoding matrix (e.g., via a TPMI included in the second control signaling) corresponding to a precoding scheme to be applied to an uplink transmission by the UE 115-b. The precoding matrix may be determined (e.g., computed) by the network node 105-b based on measurements of the first set of SRSs, along with the identity matrix and the uplink gain applied to the first set of SRSs by the repeater. For example, the network node 105-b may compute the precoding matrix in accordance with Equation 5, as described in FIG. 2 and elsewhere herein. In some cases, the second control signaling may additionally allocate the second SRS resource set (e.g., via a SRI included in the second control signaling), if the second SRS resource set was not allocated by the first control signaling. Thus, the second control signaling may inform the UE 115-a of information associated with performing a second stage of the two-stage sounding procedure.

At 320, the UE 115-a may transmit a second set of SRSs via the second SRS resource set (e.g., indicated via the first control signaling or via an SRI included in the second control signaling) during the second stage of the two-stage sounding procedure. The second set of resources for the second stage of the two-stage sounding procedure may have ben configured via the first control signaling, or the second control signaling. The UE 115-a may transmit the second SRS resource set according to the precoding scheme corresponding to the precoding matrix indicated via the second control signaling received at 315. Upon receiving the second set of SRSs, the network node 105-b may obtain (e.g., derive, calculate) information about the uplink gain applied to uplink transmissions from the UE 115-b by the repeater. Therefore, by measuring the second set of CSI-RSs, the network node 105-b may determine (e.g., detect, calculate) accurate information about the uplink channel between the UE 115-b and the network node 105-b before selecting transmission parameters for the uplink transmission by the UE 115-b.

At 325, in some examples, the UE 115-b may receive third control signaling that indicates a rank, a number of layers, and a MCS to be applied to the uplink transmission by the UE 115-b. For example, the network node 105-a may transmit the third control signaling including a RI indicating the rank, a layer indicator (LI) indicating the number of layers, or both. The rank, the number of layers, and the MCS may be based on the uplink gain applied by the repeater to the second set of SRSs, as well as the precoding matrix determined by the network node 105-b. For example, the network node 105-b may calculate the rank, the number of layers, and the MCS in accordance with Equation 6, as described in FIG. 2 and elsewhere herein. As such, the rank, the number of layers, and the MCS may be suited to the uplink channel between the UE 115-b and the network node 105-b by accounting for the uplink gain applied to uplink transmissions by the UE 115-a by the repeater. Accordingly, at 330, the UE 115-b may transmit the uplink transmission according to the rank, the number of layers, and the MCS indicated via the third control signaling. Compared to systems that use a single-stage uplink channel sounding procedure, the rank, the number of layers, and the MCS may better suit the conditions of the uplink channel between the network node 105-b and the UE 115-a when communicating via a repeater.

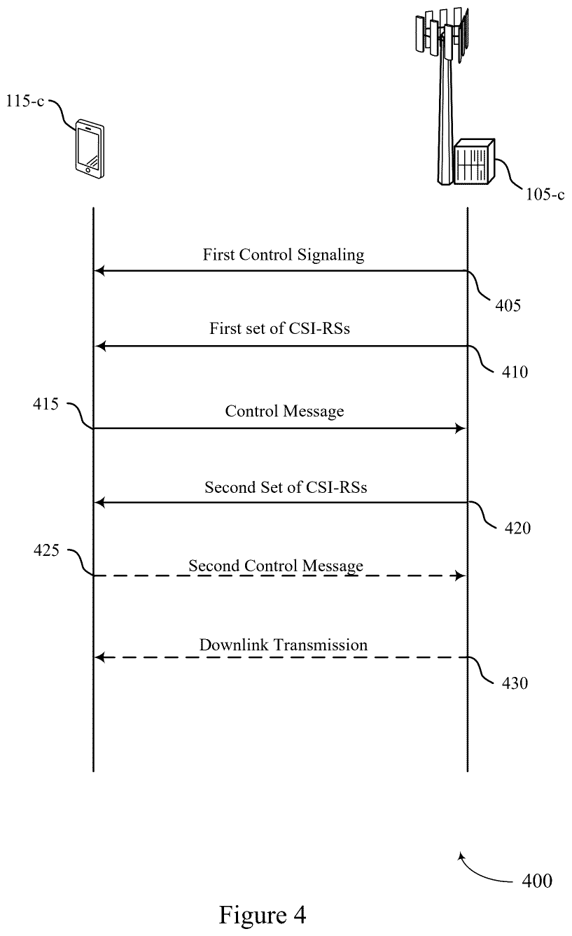

FIG. 4 shows an example of a process flow 400 that supports a two-stage channel sounding procedure in a wireless communication system. The process flow 400 may implement aspects of or may be implemented by aspects of the wireless communications system 100, the signaling configuration 200, or the process flow 300. For example, the process flow 400 may include a UE 115-c and a network node 105-c, which may be examples of the corresponding devices as described with reference to FIGS. 1-3. In some cases, the UE 115-c and the network node 105-c may communicate via a repeater, which may receive signals from the UE 115-c and amplify and forward the signals to the network node 105-c.

At 405, the UE 115-b may receive first control signaling indicating a least a first CSI-RS resource set that includes a first set of resources for one or more CSI-RSs. In some cases, the first control signaling may additionally allocate a second CSI-RS resource set including a second set of resources for one or more second CSI-RSs. As such, the first control signaling may allocate resources for the UE 115-b to perform a two-stage sounding procedure (e.g., a two-stage downlink channel sounding procedure) in which the UE 115-b may receive two sets of CSI-RSs during two respective stages of the two-stage sounding procedure.

At 410, the UE 115-c may receive a first set of CSI-RSs via the first CSI-RS resource set during a first stage of the two-stage sounding procedure. The first set of CSI-RSs may be precoded by the network node 105-c according to a precoding scheme that corresponds to an identity matrix. As such, the UE 115-c may receive the first set of CSI-RSs from the network node 105-c via the repeater, which may apply a downlink gain the first set of CSI-RSs.

At 415, the UE 115-c may transmit a control message that indicates a precoding matrix (e.g., via a TPMI included in the control message) associated with a precoding scheme to be applied to a downlink transmission by the network node 105-c. The UE 115-c may determine (e.g., compute) the precoding matrix based on measurements of the first set of CSI-RSs, the identity precoding matrix, and the downlink gain applied to the first set of CSI-RSs by the repeater. For example, the UE 115-c may calculate the precoding matrix in accordance with Equation 5, as described in FIG. 2 and elsewhere herein. In some cases, the UE 115-c may receive second control signaling which may indicate the second CSI-RS resource set (e.g., via a CSI-RS resource indicator (CSI-RS)), if the second CSI-RS resource set was not indicated via the first control signaling. As such, the control message may inform the network node 105-c of information for performing a second stage of the two-stage sounding procedure.

At 420, the UE 115-c may receive a second set of CSI-RSs via the second CSI-RS resource set (e.g., indicated by the first control signaling or by a CRI included in the second control signaling) during the second stage of the two-stage sounding procedure. The UE 115-c may receive the second set of CSI-RSs according to the precoding scheme that corresponds to the precoding matrix indicated via the control message. After receiving the second set of CSI-RSs, the UE 115-c may determine (e.g., derive, calculate) information about the downlink gain applied to downlink transmissions from the network node 105-c via the repeater. Therefore, the UE 115-c may have accurate information about a downlink channel between the network node 105-c and the repeater before selecting transmission parameters for the downlink transmission by the network node 105-c.

At 425, in some examples, the UE 115-c may transmit a second control message that indicates a rank, a number of layers, and a MCS to be applied to the downlink transmission by the network node 105-c. The rank may be indicated by the second control signaling via an RI, while the number of layers may be indicated by the control signaling via a LI. As such, the rank, the number of layers, and the MCS may be based on the downlink gain applied by the repeater to the second set of CSI-RSs, as well as the precoding matrix determined by the UE 115-c. For example, the UE 115-c may calculate the rank, the number of layers, and the MCS according to Equation 6, as described in FIG. 2 and elsewhere herein. As such, the rank, the number of layers, and the MCS may be suited to the downlink channel between the UE 115-c and the network node 105-c by accounting for the downlink gain applied by the repeater when forwarding communications between the UE 115-c and the network node 105-c. Accordingly, at 330, the network node 105-c may transmit the downlink transmission according to the rank, the number of layers, and the MCS indicated via the second control message. Compared to systems that use a single-stage downlink channel sounding procedure, the rank, the number of layers, and the MCS may better suit the conditions of the downlink channel between the network node 105-c and the UE 115-c when communicating via a repeater.

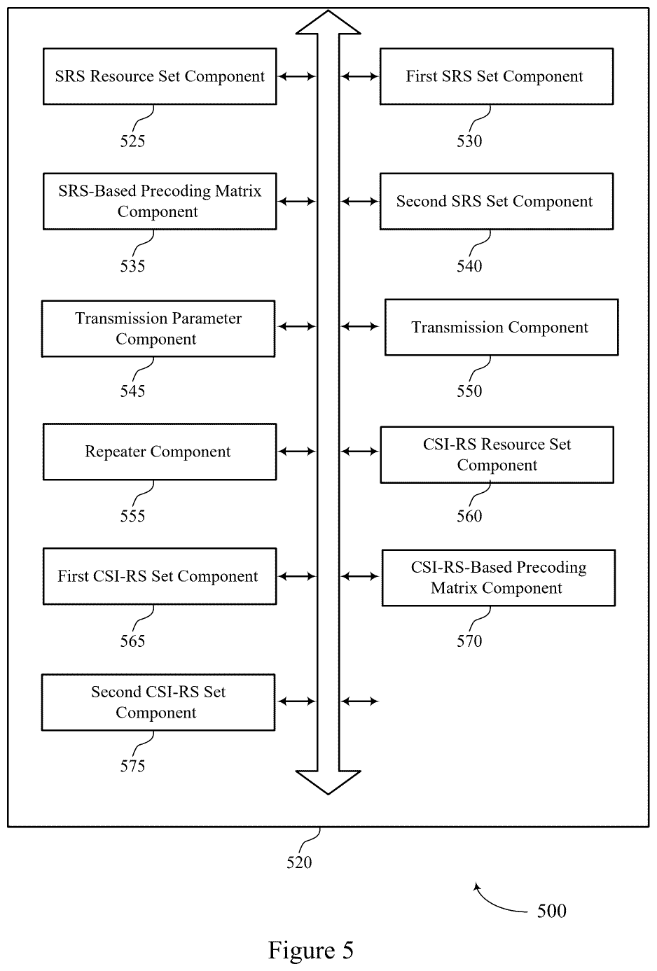

FIG. 5 shows an example 500 of a processing system 520 that supports two-stage channel sounding procedure in a wireless communication system. A processing system 520 may be an example of a processing system 140 (such as of a UE 115) and may include an SRS resource set component 525, a first SRS set component 530, an SRS-based precoding matrix component 535, a second SRS set component 540, a transmission parameter component 545, a transmission component 550, a repeater component 555, a CSI-RS resource set component 560, a first CSI-RS set component 565, a CSI-RS-based precoding matrix component 570, a second CSI-RS set component 575, or any combination thereof. A processing system 520, or various component thereof, may be an example of means for performing (such as a means for causing a UE 115 to perform) various techniques described herein.

The SRS resource set component 525 may be configured to cause the UE 115 to receive first control signaling allocating at least a first SRS resource set including a first set of resources for transmission of one or more SRSs. The first SRS set component 530 may be configured to cause the UE 115 to transmit a first set of SRSs via the first SRS resource set during a first stage of a two-stage sounding procedure. The SRS-based precoding matrix component 535 may be configured to cause the UE 115 to receive second control signaling indicating a precoding matrix based on transmitting the first set of SRSs. The second SRS set component 540 may be configured to cause the UE 115 to transmit a second set of SRSs via a second SRS resource set during a second stage of the two-stage sounding procedure according to a precoding scheme corresponding to the precoding matrix indicated via the second control signaling.

In some examples, the first control signaling allocates the second SRS resource set including a second set of resources for transmission of the second set of SRSs. In some examples, transmitting the second set of SRSs during the second stage of the two-stage sounding procedure is based on receiving the first control signaling allocating the second SRS resource set.

In some examples, the second control signaling allocates the second SRS resource set including a second set of resources for transmission of the second set of SRSs. In some examples, transmitting the second set of SRSs during the second stage of the two-stage sounding procedure is based on receiving the second control signaling allocating the second SRS resource set.

In some examples, the transmission parameter component 545 may be configured to cause the UE 115 to receive third control signaling indicating a rank, a number of layers, and a MCS to be applied to an uplink transmission by the UE based on transmitting the second set of SRSs according to the precoding scheme corresponding to the precoding matrix indicated via the second control signaling.

In some examples, the transmission component 550 may be configured to cause the UE 115 to transmit the uplink transmission according to the rank, the number of layers, and the MCS indicated via the third control signaling.

In some examples, the rank, the number of layers, and the MCS are based on an uplink gain factor corresponding to transmitting the second set of SRSs.

In some examples, to support transmitting the first set of SRSs and the second set of SRSs, the repeater component 555 may be configured to cause the UE 115 to transmit the first set of SRSs and the second set of SRSs to a network node via a repeater.

Additionally, or alternatively, the CSI-RS resource set component 560 may be configured to cause the UE 115 to receive first control signaling indicating at least a first CSI-RS resource set including a first set of resources for one or more CSI-RSs. The first CSI-RS set component 565 may be configured to cause the UE 115 to receive a first set of CSI-RSs via the first CSI-RS resource set during a first stage of a two-stage sounding procedure. The CSI-RS-based precoding matrix component 570 may be configured to cause the UE 115 to transmit a control message indicating a precoding matrix based on the first set of CSI-RSs. The second CSI-RS set component 575 may be configured to cause the UE 115 to receive a second set of CSI-RSs via a second CSI-RS resource set during a second stage of the two-stage sounding procedure according to a precoding scheme corresponding to the precoding matrix indicated via the control message.

In some examples, the first control signaling indicates the second CSI-RS resource set including a second set of resources for the second set of CSI-RSs. In some examples, receiving the second set of CSI-RSs is based on receiving the first control signaling indicating the second CSI-RS resource set.

In some examples, the CSI-RS resource set component 560 may be configured to cause the UE 115 to receive second control signaling indicating the second CSI-RS resource set including a second set of resources for the second set of CSI-RSs, where receiving the second set of CSI-RSs is based on receiving the second control signaling indicating the second CSI-RS resource set.

In some examples, the transmission parameter component 545 may be configured to cause the UE 115 to transmit a second control message indicating a rank, a number of layers, and a MCS to be applied to a downlink transmission based on receiving the second set of CSI-RSs.

In some examples, the transmission component 550 may be configured to cause the UE 115 to receive the downlink transmission based on the rank, the number of layers, and the MCS indicated via the second control message.

In some examples, the rank, the number of layers, and the MCS are based on a downlink gain factor corresponding to transmitting the second set of CSI-RSs.

In some examples, to support receiving the first set of CSI-RSs and the second set of CSI-RSs, the repeater component 555 may be configured to cause the UE 115 to receive the first set of CSI-RSs and the second set of CSI-RSs from a network node via a repeater.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for may support two-stage channel sounding for transmission parameter selection, which may improve communication reliability compared to systems using single-stage channel sounding.

In some cases, the SRS resource set component 525, the first SRS set component 530, the SRS-based precoding matrix component 535, the second SRS set component 540, the transmission parameter component 545, the transmission component 550, the repeater component 555, the CSI-RS resource set component 560, the first CSI-RS set component 565, the CSI-RS-based precoding matrix component 570, and the second CSI-RS set component 575 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the SRS resource set component 525, the first SRS set component 530, the SRS-based precoding matrix component 535, the second SRS set component 540, the transmission parameter component 545, the transmission component 550, the repeater component 555, the CSI-RS resource set component 560, the first CSI-RS set component 565, the CSI-RS-based precoding matrix component 570, and the second CSI-RS set component 575 discussed herein.

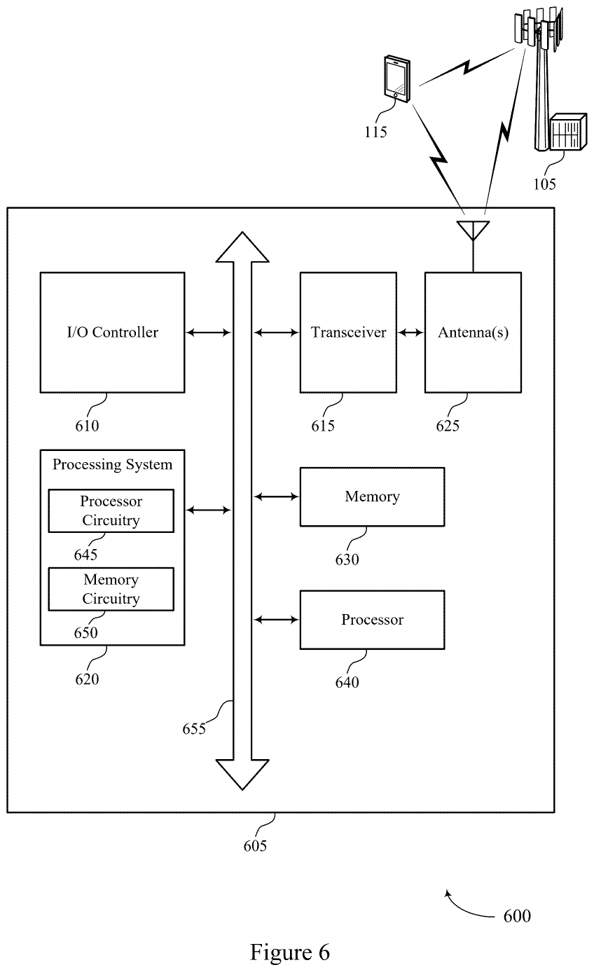

FIG. 6 shows an example of a system 600 including a device 605 that supports two-stage channel sounding procedure in a wireless communication system. The device 605 may be an example of or include components of UE 115. The device 605 may communicate (such as wirelessly) with one or more other devices (such as network nodes 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/C controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support two-stage channel sounding procedure in a wireless communication system. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for may support two-stage channel sounding for transmission parameter selection, which may improve communication reliability compared to systems using single-stage channel sounding.

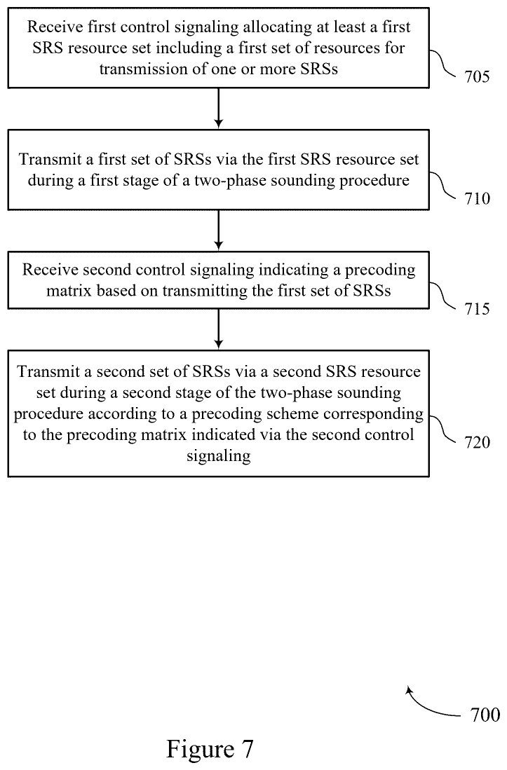

FIG. 7 shows an example of a method 700 that supports two-stage channel sounding procedure in a wireless communication system. Operations of the method 700 may be performed by a UE or its components (such as using a processing system configured to cause the UE 115 to perform one or more of the operations) as described herein.

At 705, the method may include receiving first control signaling allocating at least a first SRS resource set including a first set of resources for transmission of one or more SRSs. In some examples, aspects of the operations of 705 may be performed by an SRS resource set component 525.

At 710, the method may include transmitting a first set of SRSs via the first SRS resource set during a first stage of a two-stage sounding procedure. In some examples, aspects of the operations of 710 may be performed by a first SRS set component 530.

At 715, the method may include receiving second control signaling indicating a precoding matrix based on transmitting the first set of SRSs. In some examples, aspects of the operations of 715 may be performed by an SRS-based precoding matrix component 535.

At 720, the method may include transmitting a second set of SRSs via a second SRS resource set during a second stage of the two-stage sounding procedure according to a precoding scheme corresponding to the precoding matrix indicated via the second control signaling. In some examples, aspects of the operations of 720 may be performed by a second SRS set component 540.

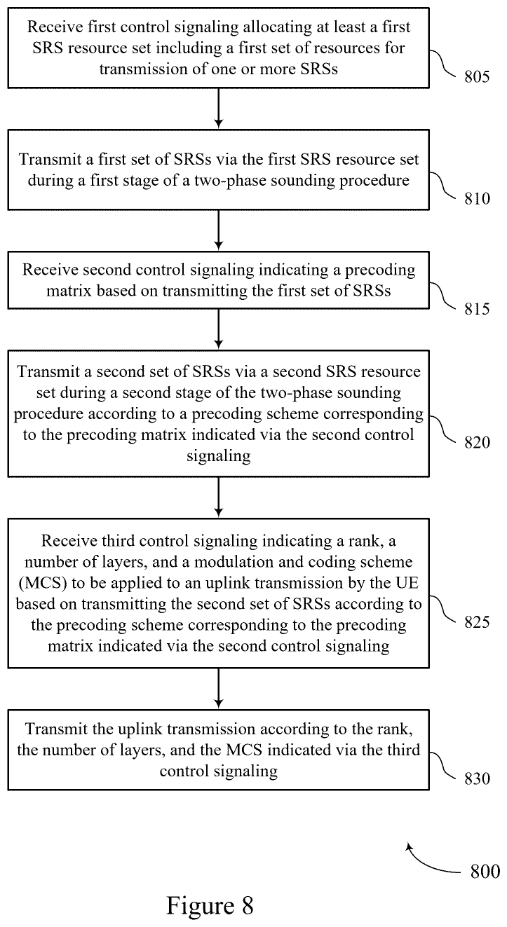

FIG. 8 shows an example of a method 800 that supports two-stage channel sounding procedure in a wireless communication system. Operations of the method 800 may be performed by a UE or its components (such as using a processing system configured to cause the UE 115 to perform one or more of the operations) as described herein.

At 805, the method may include receiving first control signaling allocating at least a first SRS resource set including a first set of resources for transmission of one or more SRSs. In some examples, aspects of the operations of 805 may be performed by an SRS resource set component 525.

At 810, the method may include transmitting a first set of SRSs via the first SRS resource set during a first stage of a two-stage sounding procedure. In some examples, aspects of the operations of 810 may be performed by a first SRS set component 530.

At 815, the method may include receiving second control signaling indicating a precoding matrix based on transmitting the first set of SRSs. In some examples, aspects of the operations of 815 may be performed by an SRS-based precoding matrix component 535.

At 820, the method may include transmitting a second set of SRSs via a second SRS resource set during a second stage of the two-stage sounding procedure according to a precoding scheme corresponding to the precoding matrix indicated via the second control signaling. In some examples, aspects of the operations of 820 may be performed by a second SRS set component 540.

At 825, the method may include receiving third control signaling indicating a rank, a number of layers, and a MCS to be applied to an uplink transmission by the UE based on transmitting the second set of SRSs according to the precoding scheme corresponding to the precoding matrix indicated via the second control signaling. In some examples, aspects of the operations of 825 may be performed by a transmission parameter component 545.

At 830, the method may include transmitting the uplink transmission according to the rank, the number of layers, and the MCS indicated via the third control signaling. In some examples, aspects of the operations of 830 may be performed by a transmission component 550.

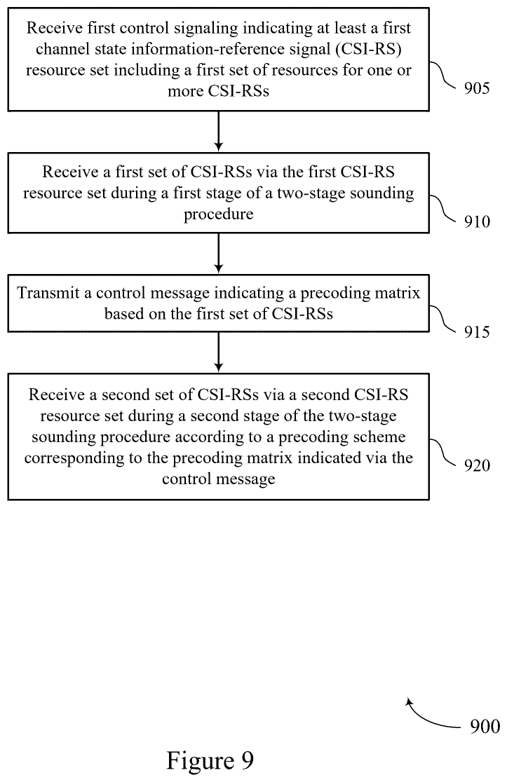

FIG. 9 shows an example of a method 900 that supports two-stage channel sounding procedure in a wireless communication system. Operations of the method 900 may be performed by a UE or its components (such as using a processing system configured to cause the UE 115 to perform one or more of the operations) as described herein.

At 905, the method may include receiving first control signaling indicating at least a first CSI-RS resource set including a first set of resources for one or more CSI-RSs. In some examples, aspects of the operations of 905 may be performed by a CSI-RS resource set component 560.

At 910, the method may include receiving a first set of CSI-RSs via the first CSI-RS resource set during a first stage of a two-stage sounding procedure. In some examples, aspects of the operations of 910 may be performed by a first CSI-RS set component 565.

At 915, the method may include transmitting a control message indicating a precoding matrix based on the first set of CSI-RSs. In some examples, aspects of the operations of 915 may be performed by a CSI-RS-based precoding matrix component 570.

At 920, the method may include receiving a second set of CSI-RSs via a second CSI-RS resource set during a second stage of the two-stage sounding procedure according to a precoding scheme corresponding to the precoding matrix indicated via the control message. In some examples, aspects of the operations of 920 may be performed by a second CSI-RS set component 575.

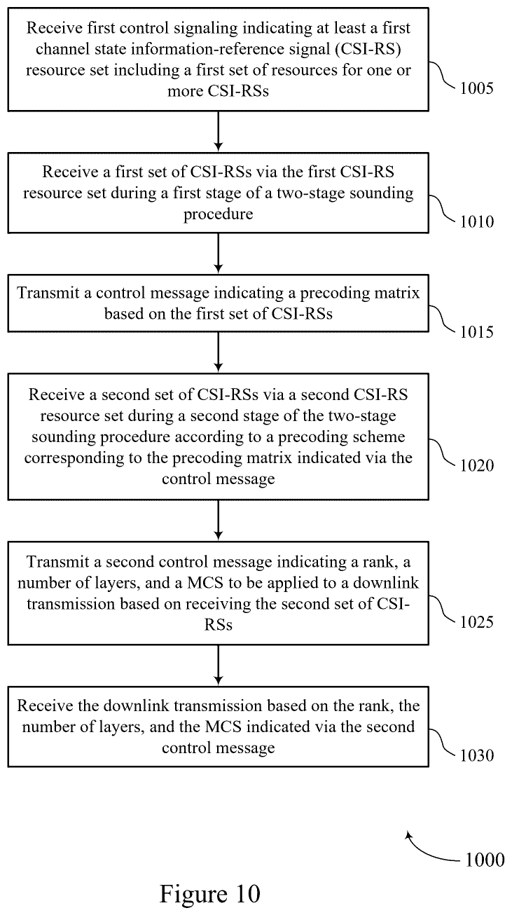

FIG. 10 shows an example of a method 1000 that supports two-stage channel sounding procedure in a wireless communication system. Operations of the method 1000 may be performed by a UE or its components (such as using a processing system configured to cause the UE 115 to perform one or more of the operations) as described herein.

At 1005, the method may include receiving first control signaling indicating at least a first CSI-RS resource set including a first set of resources for one or more CSI-RSs. In some examples, aspects of the operations of 1005 may be performed by a CSI-RS resource set component 560.

At 1010, the method may include receiving a first set of CSI-RSs via the first CSI-RS resource set during a first stage of a two-stage sounding procedure. In some examples, aspects of the operations of 1010 may be performed by a first CSI-RS set component 565.

At 1015, the method may include transmitting a control message indicating a precoding matrix based on the first set of CSI-RSs. In some examples, aspects of the operations of 1015 may be performed by a CSI-RS-based precoding matrix component 570.

At 1020, the method may include receiving a second set of CSI-RSs via a second CSI-RS resource set during a second stage of the two-stage sounding procedure according to a precoding scheme corresponding to the precoding matrix indicated via the control message. In some examples, aspects of the operations of 1020 may be performed by a second CSI-RS set component 575.

At 1025, the method may include transmitting a second control message indicating a rank, a number of layers, and a MCS to be applied to a downlink transmission based on receiving the second set of CSI-RSs. In some examples, aspects of the operations of 1025 may be performed by a transmission parameter component 545.

At 1030, the method may include receiving the downlink transmission based on the rank, the number of layers, and the MCS indicated via the second control message. In some examples, aspects of the operations of 1030 may be performed by a transmission component 550.

Implementation examples are described in the following numbered clauses:

Aspect 1: A method for wireless communications at a UE, comprising: receiving first control signaling allocating at least a first SRS resource set comprising a first set of resources for transmission of one or more SRSs; transmitting a first set of SRSs via the first SRS resource set during a first stage of a two-stage sounding procedure; receiving second control signaling indicating a precoding matrix based at least in part on transmitting the first set of SRSs; and transmitting a second set of SRSs via a second SRS resource set during a second stage of the two-stage sounding procedure according to a precoding scheme corresponding to the precoding matrix indicated via the second control signaling.

Aspect 2: The method of aspect 1, wherein the first control signaling allocates the second SRS resource set comprising a second set of resources for transmission of the second set of SRSs, transmitting the second set of SRSs during the second stage of the two-stage sounding procedure is based at least in part on receiving the first control signaling allocating the second SRS resource set.

Aspect 3: The method of aspect 1, wherein the second control signaling allocates the second SRS resource set comprising a second set of resources for transmission of the second set of SRSs, transmitting the second set of SRSs during the second stage of the two-stage sounding procedure is based at least in part on receiving the second control signaling allocating the second SRS resource set.

Aspect 4: The method of any of aspects 1 through 3, further comprising: receiving third control signaling indicating a rank, a number of layers, and a MCS to be applied to an uplink transmission by the UE based at least in part on transmitting the second set of SRSs according to the precoding scheme corresponding to the precoding matrix indicated via the second control signaling.

Aspect 5: The method of aspect 4, further comprising: transmitting the uplink transmission according to the rank, the number of layers, and the MCS indicated via the third control signaling.

Aspect 6: The method of any of aspects 4 through 5, wherein the rank, the number of layers, and the MCS are based at least in part on an uplink gain factor corresponding to transmitting the second set of SRSs.

Aspect 7: The method of any of aspects 1 through 6, wherein transmitting the first set of SRSs and the second set of SRSs further comprises: transmitting the first set of SRSs and the second set of SRSs to a network node via a repeater.

Aspect 8: A method for wireless communications at a UE, comprising: receiving first control signaling indicating at least a first CSI-RS resource set comprising a first set of resources for one or more CSI-RSs; receiving a first set of CSI-RSs via the first CSI-RS resource set during a first stage of a two-stage sounding procedure; transmitting a control message indicating a precoding matrix based at least in part on the first set of CSI-RSs; and receiving a second set of CSI-RSs via a second CSI-RS resource set during a second stage of the two-stage sounding procedure according to a precoding scheme corresponding to the precoding matrix indicated via the control message.

Aspect 9: The method of aspect 8, wherein the first control signaling indicates the second CSI-RS resource set comprising a second set of resources for the second set of CSI-RSs, receiving the second set of CSI-RSs is based at least in part on receiving the first control signaling indicating the second CSI-RS resource set.

Aspect 10: The method of aspect 8, further comprising: receiving second control signaling indicating the second CSI-RS resource set comprising a second set of resources for the second set of CSI-RSs, wherein receiving the second set of CSI-RSs is based at least in part on receiving the second control signaling indicating the second CSI-RS resource set.

Aspect 11: The method of any of aspects 8 through 10, further comprising: transmitting a second control message indicating a rank, a number of layers, and a MCS to be applied to a downlink transmission based at least in part on receiving the second set of CSI-RSs.

Aspect 12: The method of aspect 11, further comprising: receiving the downlink transmission based at least in part on the rank, the number of layers, and the MCS indicated via the second control message.

Aspect 13: The method of any of aspects 11 through 12, wherein the rank, the number of layers, and the MCS are based at least in part on a downlink gain factor corresponding to transmitting the second set of CSI-RSs.

Aspect 14: The method of any of aspects 8 through 13, wherein receiving the first set of CSI-RSs and the second set of CSI-RSs further comprises: receiving the first set of CSI-RSs and the second set of CSI-RSs from a network node via a repeater.

Aspect 15: A UE for wireless communications, comprising a processing system that includes processor circuitry and memory circuitry that stores code, the processing system configured to cause the UE to perform a method of any of aspects 1 through 7.

Aspect 16: A UE for wireless communications, comprising at least one means for performing a method of any of aspects 1 through 7.

Aspect 17: A non-transitory computer-readable medium storing code for wireless communications, the code comprising instructions executable by one or more processors to perform a method of any of aspects 1 through 7.

Aspect 18: A UE for wireless communications, comprising a processing system that includes processor circuitry and memory circuitry that stores code, the processing system configured to cause the UE to perform a method of any of aspects 8 through 14.

Aspect 19: A UE for wireless communications, comprising at least one means for performing a method of any of aspects 8 through 14.

Aspect 20: A non-transitory computer-readable medium storing code for wireless communications, the code comprising instructions executable by one or more processors to perform a method of any of aspects 8 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive first control signaling allocating at least a first sounding reference signal (SRS) resource set comprising a first set of resources for transmission of one or more SRSs;
transmit a first set of SRSs via the first SRS resource set during a first stage of a two-stage sounding procedure;
receive second control signaling indicating a precoding matrix based at least in part on transmitting the first set of SRSs; and
transmit a second set of SRSs via a second SRS resource set during a second stage of the two-stage sounding procedure according to a precoding scheme corresponding to the precoding matrix indicated via the second control signaling.

2. The UE of claim 1, wherein the first control signaling allocates the second SRS resource set comprising a second set of resources for transmission of the second set of SRSs, wherein transmitting the second set of SRSs during the second stage of the two-stage sounding procedure is based at least in part on receiving the first control signaling allocating the second SRS resource set.

3. The UE of claim 1, wherein the second control signaling allocates the second SRS resource set comprising a second set of resources for transmission of the second set of SRSs, wherein transmitting the second set of SRSs during the second stage of the two-stage sounding procedure is based at least in part on receiving the second control signaling allocating the second SRS resource set.

4. The UE of claim 1, wherein the processing system is further configured to cause the UE to:
receive third control signaling indicating a rank, a number of layers, and a modulation and coding scheme (MCS) to be applied to an uplink transmission by the UE based at least in part on transmitting the second set of SRSs according to the precoding scheme corresponding to the precoding matrix indicated via the second control signaling.

5. The UE of claim 4, wherein the processing system is further configured to cause the UE to:
transmit the uplink transmission according to the rank, the number of layers, and the MCS indicated via the third control signaling.

6. The UE of claim 4, wherein the rank, the number of layers, and the MCS are based at least in part on an uplink gain factor corresponding to transmitting the second set of SRSs.

7. The UE of claim 1, wherein, to transmit the first set of SRSs and the second set of SRSs, the processing system is further configured to cause the UE to:
transmit the first set of SRSs and the second set of SRSs to a network node via a repeater.

8. A user equipment (UE), comprising:
a processing system that includes processor circuitry and memory circuitry that stores code, the processing system configured to cause the UE to:
receive first control signaling indicating at least a first CSI-RS resource set comprising a first set of resources for one or more CSI-RSs;
receive a first set of CSI-RSs via the first CSI-RS resource set during a first stage of a two-stage sounding procedure;
transmit a control message indicating a precoding matrix based at least in part on the first set of CSI-RSs; and
receive a second set of CSI-RSs via a second CSI-RS resource set during a second stage of the two-stage sounding procedure according to a precoding scheme corresponding to the precoding matrix indicated via the control message.

9. The UE of claim 8, wherein the first control signaling indicates the second CSI-RS resource set comprising a second set of resources for the second set of CSI-RSs, wherein receiving the second set of CSI-RSs is based at least in part on receiving the first control signaling indicating the second CSI-RS resource set.

10. The UE of claim 8, wherein the processing system is further configured to cause the UE to:
receive second control signaling indicating the second CSI-RS resource set comprising a second set of resources for the second set of CSI-RSs, wherein receiving the second set of CSI-RSs is based at least in part on receiving the second control signaling indicating the second CSI-RS resource set.

11. The UE of claim 8, wherein the processing system is further configured to cause the UE to:
transmit a second control message indicating a rank, a number of layers, and a MCS to be applied to a downlink transmission based at least in part on receiving the second set of CSI-RSs.

12. The UE of claim 11, wherein the processing system is further configured to cause the UE to:
receive the downlink transmission based at least in part on the rank, the number of layers, and the MCS indicated via the second control message.

13. The UE of claim 11, wherein the rank, the number of layers, and the MCS are based at least in part on a downlink gain factor corresponding to transmitting the second set of CSI-RSs.

14. The UE of claim 8, wherein, to receive the first set of CSI-RSs and the second set of CSI-RSs, the processing system is further configured to cause the UE to:
receive the first set of CSI-RSs and the second set of CSI-RSs from a network node via a repeater.

15. A method for wireless communications at a user equipment (UE), comprising:
receiving first control signaling allocating at least a first SRS resource set comprising a first set of resources for transmission of one or more SRSs;
transmitting a first set of SRSs via the first SRS resource set during a first stage of a two-stage sounding procedure;
receiving second control signaling indicating a precoding matrix based at least in part on transmitting the first set of SRSs; and
transmitting a second set of SRSs via a second SRS resource set during a second stage of the two-stage sounding procedure according to a precoding scheme corresponding to the precoding matrix indicated via the second control signaling.

16. The method of claim 15, wherein the first control signaling allocates the second SRS resource set comprising a second set of resources for transmission of the second set of SRSs, wherein transmitting the second set of SRSs during the second stage of the two-stage sounding procedure is based at least in part on receiving the first control signaling allocating the second SRS resource set.

17. The method of claim 15, wherein the second control signaling allocates the second SRS resource set comprising a second set of resources for transmission of the second set of SRSs, wherein transmitting the second set of SRSs during the second stage of the two-stage sounding procedure is based at least in part on receiving the second control signaling allocating the second SRS resource set.

18. The method of claim 15, further comprising:
receiving third control signaling indicating a rank, a number of layers, and a MCS to be applied to an uplink transmission by the UE based at least in part on transmitting the second set of SRSs according to the precoding scheme corresponding to the precoding matrix indicated via the second control signaling.

19. The method of claim 18, further comprising:
transmitting the uplink transmission according to the rank, the number of layers, and the MCS indicated via the third control signaling.

20. The method of claim 18, wherein the rank, the number of layers, and the MCS are based at least in part on an uplink gain factor corresponding to transmitting the second set of SRSs.
